(19) United States
(12) Patent Application Publication
(10) Pub. No.: US 2026/0243606 A1
(43) Pub. Date: Aug. 20, 2026

(54) MEASUREMENT SENSOR FOR A THERMAL MEASUREMENT VARIABLE AND MEASUREMENT STATION COMPRISING SUCH A MEASUREMENT SENSOR

(71) Applicant: Endress+Hauser Wetzer GmbH+Co. KG, Nesselwang (DE)

(72) Inventors: Marc Schalles, Erfurt (DE); Alfred Umkehrer, Hopferau (DE); Pavo Vrdoljak, Nesselwang (DE); Stephan Wiedemann, Bihlerdorf (DE); Georg Wolf, Marktoberdorf (DE)

(21) Appl. No.: 19/122,915

(22) PCT Filed: Sep. 7, 2023
(86) PCT No.: PCT/EP2023/074660

§ 371 Date: Apr. 21, 2025

(30) Foreign Application Priority Data
Oct. 19, 2022 (DE) 10 2022 127 611.2

(51) Int. Cl. G01K 1/143; G01K 1/16

(52) U.S. Cl. CPC G01K 1/143; G01K 1/16

(57) ABSTRACT

A temperature sensor includes a body with a chamber for a sensor element. The longitudinal axis of the chamber is less than four radii of the chamber from a surface, and the intersection points of normal vectors of said surface define a guide curve. A distance between the guide curve and the axis and a direction vector of the guide curve at the intersection point of the two span a reference plane with an angle of 25° to the longitudinal axis of the chamber. The sensor module comprises a sensor element in the chamber, a module base body a distance from the sensor element, and a thermal bridge body between the sensor element and the module base body. Along the axis of the chamber, cross-sections are larger than those of the bridge body, which is bonded to the module base body, which is bonded to the wall of the chamber.

The invention relates to a measurement sensor for determining a thermal measurement variable, in particular a temperature of a medium or a thermally determined flow rate of the medium in a container, for example a tank or a pipeline.

For this purpose, a temperature sensor element is to be brought into thermal contact with the container, for which purpose a coupling element with a contact surface and a sensor chamber is provided, into which the temperature sensor element is introduced. So-called thin-film and thick-film sensors and so-called thermistors (also referred to as NTC thermistors), among others, have become known as a temperature sensor element in the form of a resistance element. In the case of a thin-film sensor, in particular a resistance temperature detector (RTD), for example, a sensor element provided with connecting wires and mounted on a carrier substrate is used, the back side of the carrier substrate usually having a metal coating. As temperature sensor elements, so-called resistance elements, for example in the form of platinum elements, are also used, which are, inter alia, also commercially available under the designations PT10, PT100, and PT1000.

In the case of temperature sensor elements in the form of thermocouples, however, the temperature is determined by a thermovoltage which arises between the unilaterally connected thermo wires made of different materials. Thermocouples according to the DIN standard IEC584, e.g., thermocouples of type K, J, N, S, R, B, T, or E, can in particular be used as temperature sensor elements for temperature measurement.

The accuracy of the temperature measurement is highly dependent on the respective thermal contacts and the prevailing heat conduction. The heat flows between the medium, the container in which the medium is located, the measurement sensor and the process environment play a critical role here. For a reliable temperature determination, it is important that the respective temperature sensor and the medium are located substantially in thermal equilibrium, at least for a certain time required to measure the temperature. The time it takes a measurement sensor to respond to a temperature change is also referred to as the response time of the measurement sensor.

High measurement accuracy can be achieved in particular when a coupling element is immersed in the medium. Thus, numerous measurement sensors have become known, in which a coupling element is more or less brought into direct contact with the medium. In this way, good thermal coupling between the medium and the temperature sensor element can be achieved.

However, non-invasive determination of the temperature is advantageous for various processes and for many containers, in particular small tanks or pipelines. Measurement sensors whose coupling elements can be fastened from the outside to the container in which the medium is located have also become known, for example from documents, such as DE 10 2014 118 206 A1 or DE 10 2015 113 237A1. This requires that various additional aspects be taken into account in order to ensure good thermal coupling. For example, the mechanical and thus also the thermal contact between the tank and the coupling element is critical to the measurement accuracy that can be achieved. Further different embodiments of measurement sensors for non-invasive temperature measurement are described, for example, in documents US2016/0047697A1, DE102005040699B3, EP3230704B1, or EP2038625B1.

A central problem in non-invasive temperature determination is the heat dissipation from the process to the environment. This results in a significantly higher measurement error than when the coupling element is introduced directly into the process. Heat dissipation can also occur via thermal bridges formed by components of the measurement sensor.

The same problem also results, for example, when a measurement sensor based on a thermal measurement principle is used for flow measurement. Such measurement sensors typically comprise at least two sensor elements with at least one temperature sensor element and at least one heating element or heatable temperature sensor, wherein, in the non-invasive case, a coupling element resting on a pipe wall is to be used to bring the sensor elements into thermal contact with a medium flowing in the pipe.

Based on the described problem of heat dissipation in the case of non-invasive thermal measurement sensors, the object of the invention is to provide a measurement sensor by means of which the non-invasive determination of a thermal measurement variable of a medium can be improved.

The object is achieved according to the invention by the measurement sensor according to independent claim 1 and the measurement station according to independent claim 14. Advantageous embodiments are the subject matter of the dependent claims.

The measurement sensor according to the invention for determining and/or monitoring a thermal process variable, in particular a temperature, or a thermally determined flow rate of a medium in a container by contacting a surface of the container by means of a contact surface comprises
a coupling element; and
a sensor module;
wherein the coupling element comprises:
   a main body with a contact surface for contacting the surface of the container,
   wherein the coupling element has a sensor chamber, which is cylindrical at least in sections, for receiving a sensor element for determining and/or monitoring the process variable,
   wherein the sensor chamber is arranged at least in sections in the main body,
   wherein a longitudinal axis of the sensor chamber is at a distance of not more than four radii, for example not more than two radii, in particular not more than one radius, of the sensor chamber from the contact surface, wherein
   the contact surface has multiple normal vectors, the intersection points of which define a guide curve, wherein a minimum distance vector is given between the guide curve and the longitudinal axis of the bore, wherein the distance vector and a direction vector of the guide curve at the intersection point of the guide curve with the distance vector span a reference plane, to which the longitudinal axis of the bore has an angle of not less than 20°, for example not less than 60°, and in particular not less than 80°;
   wherein the sensor module comprises:
   at least one sensor element for detecting a temperature;
   at least one module base body; and
   at least one thermal bridge body;
   wherein the sensor element is arranged in a first end portion of the sensor chamber,
   wherein the module base body is arranged at a second end portion of the sensor chamber that faces away from the first end portion,
   wherein the thermal bridge body extends in the sensor chamber at least over a portion that extends between the sensor element and the module base body,
   wherein, along the longitudinal axis of the sensor chamber, cross-sections of the sensor chamber are larger than the respective coplanar cross-sections of the thermal bridge bodies,
   wherein the thermal bridge body is firmly bonded to the module base body, and
   wherein the module base body is firmly bonded to the coupling element in an end portion of the sensor chamber that faces away from the sensor element.

In an embodiment of the invention, the thermal bridge body can in particular comprise a metal material or a ceramic material.

Due to the firmly bonded connections both between the thermal bridge body and the module base body and between the module base body and the coupling element, a temperature gradient along the thermal bridge body is minimized, whereby heat dissipation along the thermal bridge body is minimized.

It is advantageous if the longitudinal axis of the sensor chamber containing the sensor element is aligned at an angle to the guide curve of the contact surface since the guide curve is flush with the guide curve of the container when the measurement sensor is installed. Thus, the longitudinal axis of the sensor chamber is also at an angle to the guide curve of the container, which allows for a larger distance between the module base body and the tank wall. This makes handling the measurement sensor easier, in particular if a connector coupling or other operating elements are arranged on the module base body.

In a development of the invention, the contact surface has the shape of a portion of a lateral cylinder surface, wherein the guide curve forms a cylinder axis to the lateral cylinder surface.

In a development of the invention, the coupling element furthermore comprises a shaft, which extends out of the main body, wherein the sensor chamber extends through the shaft, wherein the shaft is connected to the main body in particular by means of a press fit or in a firmly bonded manner.

In a development of the invention, the sensor chamber is closed at the first end portion, wherein the sensor chamber extends from a point of minimum distance of the contact surface to the longitudinal axis of the sensor chamber not more than eight, diameters of the sensor chamber at the point of minimum distance in the direction of the end region.

In a development of the invention, the contact surface has an opening to the sensor chamber (10), wherein the sensor element is arranged in the region of the opening with respect to the longitudinal axis of the sensor chamber.

In a development of the invention, the sensor element is fixed with a potting compound, wherein, in particular, the potting compound closes the opening and preferably has a surface contour that follows the contour of the contact surface (9) in the vicinity of the opening.

In a development of the invention, the at least one thermal bridge body comprises at least two electrical lines connected to the sensor element,
wherein the module base body comprises an, in particular metal, ring body and an electrical insulator body,
wherein the ring body surrounds the electrical insulator body in a firmly bonded manner,
wherein the at least two electrical lines are firmly bonded to the electrical insulator body, and
wherein the ring body is firmly bonded to the wall of the sensor chamber.

In a development of the invention, the at least one thermal bridge body comprises at least one cylindrical sleeve, which is inserted into the sensor chamber, wherein the sensor element is arranged in the sleeve, wherein the sleeve is firmly bonded to the module base body.

In an embodiment of the invention, the sleeve is connected to the module base body by welding, soldering, gluing, and/or casting.

In an embodiment of this development of the invention, electrical lines, which contact the sensor element and extend from the sensor element to the module base body, are routed in the sleeve.

In a development of the invention, a unit comprising at least partially a material having anisotropic thermal conductivity, preferably an at least partially carbon-containing material, in particular graphite or hexagonal boron nitride, is arranged in the region of the contact surface, or the main body consists of the material having anisotropic thermal conductivity in a region facing the contact surface.

In a development of the invention, a thermal insulation made of a thermally insulating material is arranged in a region of the main body that faces away from the contact surface and the sensor chamber, which thermal insulation at least partially surrounds the main body, or wherein the main body in the region consists of the thermally insulating material, wherein the thermally lower thermally insulating material has a thermal conductivity that is at least four times lower, in particular at least eight times lower, than that of the material of the main body in the region of the contact surface.

In a development of the invention, the main body is constructed from at least two components, in particular in the form of a layered structure.

In a development of the invention, the measurement sensor comprises fastening means for fastening the main body to the container. For example, the fastening means can be fastener straps, or means for producing a clamping screw connection, a screw connection, a spring connection, or the like.

In a development of the invention, the main body of the coupling element comprises at least partially a sintered material or a composite material.

In a development of the invention, the coupling element is designed in one piece and is produced, in particular, by means of a generative manufacturing process, preferably by means of a 3D printing process, or wherein the coupling element has at least two, in particular separately manufactured, coupling components.

In a development of the invention, the measurement sensor comprises at least one component from a list of components, which comprises: a plug connector coupling; an on-site electronics module for driving the sensor element and/or for processing primary signals of the sensor element, wherein the component is firmly connected to the module base body and in particular is arranged in the module base body.

The measurement station according to the invention comprises a measurement sensor according to the invention and a container for containing a medium whose thermal process variable is to be determined by means of the measurement sensor,
wherein the contact surface rests against a surface portion of the container that is complementary to it, wherein, in particular, the guide curve of the contact surface coincides with a guide curve of the surface portion.

In a development of the invention, the container comprises a pipeline section for guiding the medium, wherein the surface portion is formed in the pipeline section.

In an embodiment, the measurement station comprises at least one reference element for in-situ calibration and/or validation of at least the measurement sensor, which reference element is fastened to the outer wall of the container and consists at least partially of at least one material, for which material at least one phase transition at at least one specified phase transition temperature occurs in the temperature range relevant to the calibration of the measurement sensor, for which phase transition the material remains in the solid phase, as described in EP 2 612 122 B1.

In another embodiment, the contact surface consists at least in part of a deformable, in particular flexible or ductile, material, which is designed such that it can be adapted to a contour of the outer wall of the container. The contact surface can accordingly be adapted to the surface of the wall of the container. This has the advantage that the coupling element can compensate for small nominal width differences, shape deviations and/or unevenness of the surface of the respective wall of the container.

The measurement sensors or measurement stations according to the invention can be designed in particular for temperature measurement, but the invention also includes measurement sensors or measurement stations for flow measurement. In this case, the measurement sensor also comprises a heating element, which is used to heat the medium through a tank wall, wherein the heating element can be fastened by means of a coupling element. The sensor element and a region surrounding the sensor element can be heated to a specifiable temperature by means of the heating element. In the context of the present invention, the term “flow” includes both a volume flow and a mass flow of the medium. Likewise, a flow rate or flow velocity of the medium can be determined.

For example, the flow can be determined in two different ways. According to a first measurement principle, a sensor element is heated such that its temperature remains substantially constant. In known, and at least temporarily constant medium properties, such as the medium temperature, its density or also composition, the mass flow of the medium through the pipeline can be determined on the basis of the heating power required to maintain the temperature at a constant value. In this case, the medium temperature means the temperature of the medium without any additional heat input from a heating element. In contrast, in the second measurement principle, the heating element is operated at a constant heating power and the temperature of the medium downstream of the heating element is measured. In this case, the measured temperature of the medium gives information about the mass flow. In addition, however, other measurement principles have also become known, such as transient methods, in which the heating power or the temperature is modulated.

For example, the heating element can be designed in the form of a resistive heater that is heated via the conversion of electrical power supplied to it, for example as a result of an increased supply of power.

The invention will be explained in more detail with reference to the following figures. In the drawings:

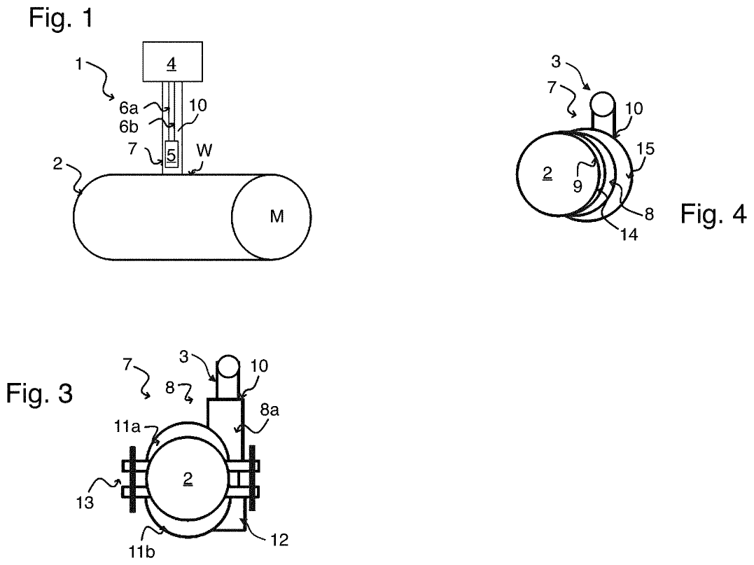

FIG. 1: shows a measurement sensor for non-invasive temperature measurement according to the prior art;

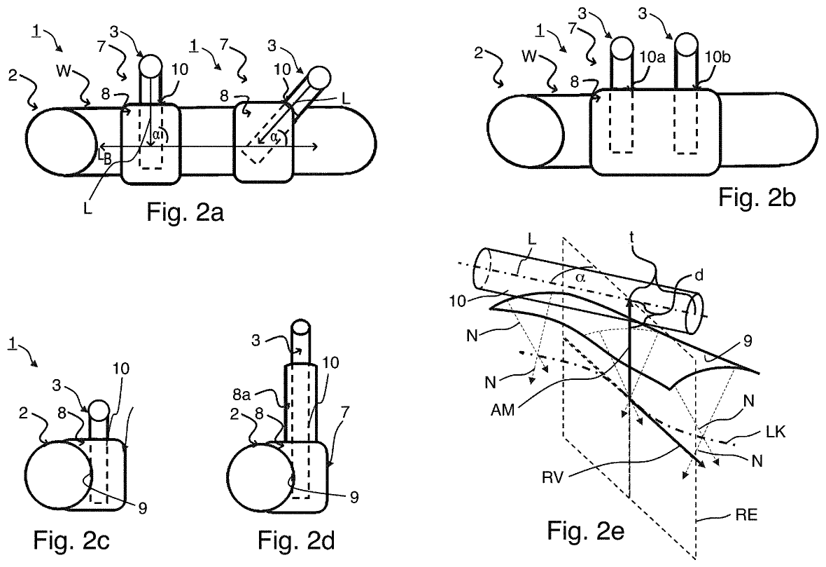

FIG. 2a-b: are schematic plan views of embodiments of one-piece coupling elements of measurement sensors according to the invention on a pipeline;

FIG. 2c-d: are schematic cross-sections of embodiments of one-piece coupling elements of measurement sensors according to the invention on a pipeline;

FIG. 2e: is a sketch for explaining geometric properties of coupling elements of measurement sensors according to the invention; and

FIG. 3: is a schematic representation of an embodiment of a measurement sensor according to the invention with a multi-part coupling element with fastening means on a pipeline;

FIG. 4: is a schematic representation of a coupling element of measurement sensors according to the invention with thermal insulation;

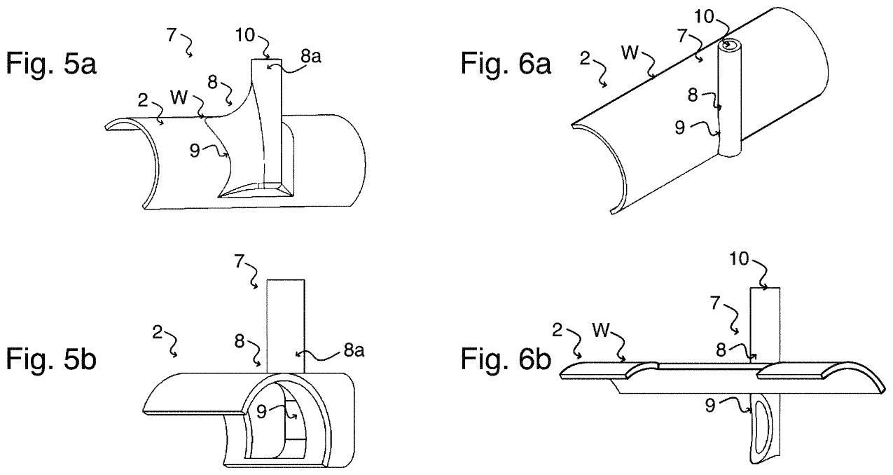

FIG. 5a-b: show a first embodiment of a coupling element of a measurement sensor according to the invention that was produced in one piece;

FIG. 6a-b: show a second embodiment of a coupling element produced in one piece; and

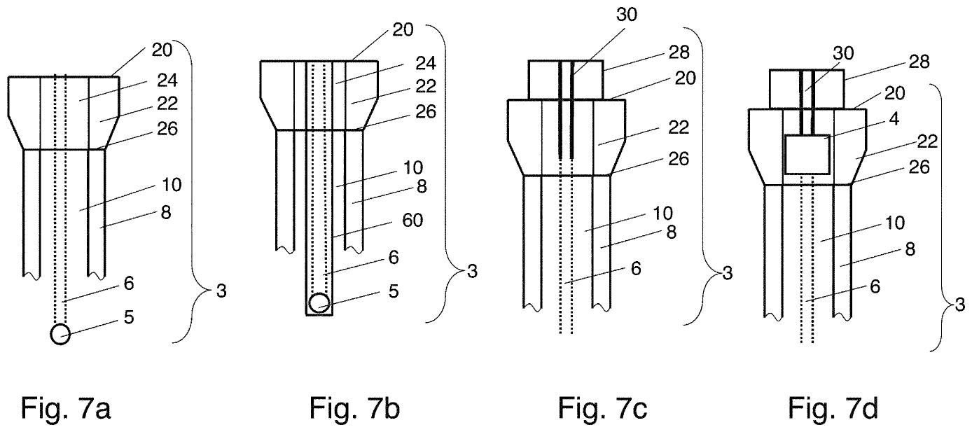

FIG. 7a-d: show details for mounting the sensor module in a coupling element of a measurement sensor according to the invention.

In the figures, identical elements are respectively provided with the same reference signs. The embodiments from the various figures can also be combined with one another as desired. In addition, although all figures relate to containers in the form of pipelines and to measurement sensors for determining a medium temperature, the present invention is by no means limited to pipelines or the temperature measurement. Rather, the respective considerations can be readily applied to other types of containers and measurement sensors.

FIG. 1 is a schematic representation of a measurement sensor 1 according to the prior art with a coupling element 7, a sensor element 10, and an electronics module 4. The measurement sensor 1 is used to detect the temperature T of a medium M located in a container 2, here in the form of a pipeline. For this purpose, the thermometer 1 does not project into the pipeline 2, but rather is placed on a wall W of the pipeline 2 from the outside for non-invasive temperature determination.

The coupling element 7 contains a sensor chamber 10, in which the sensor element 5 in the form of a temperature sensor, which comprises a resistance element, is arranged. The sensor element 5 is electrically contacted via the connection lines 6a, 6b and connected to the electronics module 4. While the measurement sensor 1 shown has a compact design with an integrated electronics module 4, the electronics module 4 can also be arranged separately from the measuring insert 3 in other measurement sensors 1. As already explained, the measurement accuracy of such a measurement sensor 1 depends to a large extent on the materials used and on the contacting means, in particular thermal contacting means, in particular in the region of the temperature sensor. The temperature sensor is in thermal contact with the medium M indirectly, i.e., via the coupling element 7 and via the wall W of the container 2. Heat dissipation from the coupling element 7 to the environment, which can lead to an undesired temperature gradient in the region of the temperature sensor 5, also plays a major role in this context. In order to suitably counteract these problems, an alternative embodiment for non-invasive determination of a process variable by means of the measurement sensor 1 according to the invention is proposed within the scope of the present invention, as shown in FIG. 2 ff for some exemplary embodiments.

The measurement sensors 1 according to the invention have coupling elements 7, as shown in FIG. 2a to 2d. Each coupling element 7 has a main body 8 with a contact surface 9, by means of which the main body 8 can be placed flatly and in particular precisely against a wall W of a container 2. The contact surface 9 is preferably designed to correspond to a surface O of the wall W of the container 2, for example in the shape of a cylindrical shell. The coupling element 7 furthermore comprises a sensor chamber 10, which can be prepared, for example, by a bore in the main body 8 and/or in a shaft 8a connected thereto, and whose position is indicated in the drawings by a dashed line. A sensor element for temperature measurement by means of a sensor module 3 is introduced into the sensor chamber 10. Details in this regard are explained further below. A longitudinal axis L of the sensor chamber 10, which is cylindrical at least in sections, is askew relative to a longitudinal axis L_{B} of the container 2.

The alignment of the sensor chamber without reference to the container is now explained with reference to FIG. 2e. As mentioned, the coupling element 7 comprises a contact surface 9, wherein a longitudinal axis L of the sensor chamber 10 has a distance d to the contact surface 9, wherein the distance d in the representation is not more than two radii. The contact surface (9) also has multiple normal vectors (N), the intersection points of which define a guide curve (LK). For example, if the contact surface has the shape of a cylindrical shell portion, the resulting guide curve is the associated cylinder axis. However, the sketch in FIG. 2e shows a generalized case.A minimum distance vector (AM) is given between the guide curve (LK) and the longitudinal axis (L) of the sensor chamber (10), wherein the distance vector (AM) and a direction vector (RV) of the guide curve (LK) at the intersection point of the guide curve (LK) with the distance vector (AM) span a reference plane (RE), to which the longitudinal axis (L) of the sensor chamber (10) has an angle (α) of not less than 25°, for example not less than 60°, and in particular not less than 80°.

On the left, FIG. 2a shows a first design of a coupling element 7 of a measurement sensor 1 according to the invention, in which an angle α between the longitudinal axis Lk of the sensor chamber 10 and a longitudinal axis L_{B} of the pipeline 2 is α=90°. Here, this would also be the angle between the reference plane and the longitudinal axis L of the sensor chamber 10. In contrast, in the case of the coupling element 7 shown on the right, α=45°. It is also conceivable for the coupling element 7 to have two bores 10a and 10b, each of which is used to receive a sensor module 3a, 3b, as illustrated in FIG. 2b. In the case of multiple bores 10a and 10b, the respective angles α can be the same, as in the case of FIG. 2b, or different.

Different variants are also conceivable for the design of the main body 8, as illustrated for example in FIG. 2c-d. The embodiment according to FIG. 2c is a massive main body 8, which can bring advantages in particular with regard to thermal insulation with respect to an environment of the coupling element 7 and the sensor module 3. In addition, such an embodiment is typically more mechanically robust. In the embodiment according to FIG. 2d, the coupling element 7 additionally comprises a shaft 8a, wherein the sensor chamber 10 for receiving the sensor module 3 extends at least in sections through the shaft 8a. The shaft 8a has various functions; in particular, it is used to improve heat conduction from the wall W of the container 2 to the sensor module 3 and to enlarge a region having homogeneous temperature distribution around the sensor module 3. In addition, the shaft 8a can be used to improve the thermal insulation and/or the mechanical stability of the measurement sensor or of the sensor module 3 in the sensor chamber 10 of the main body 8.

FIG. 3 shows an embodiment with a multi-part coupling element 7 and with clamping screws 13 for fastening. The main body 8 is designed in two parts and with a shaft 8a and has two coupling components in the form of half shells 11a and 11b, which can be arranged around a pipeline 2. The sensor chamber 10 extends in the region of both half shells 11a and 11b and is closed in an end region 12. It should be pointed out that, in other embodiments, the main body 8 can also have more than two coupling components, and that, even in the case of two coupling components, these do not necessarily have to be designed in the form of half shells 11a and 11b. Rather, numerous different variants are conceivable, all of which fall under the present invention.

FIG. 4 shows a coupling element 7 having a unit 14 comprising a material having anisotropic thermal conductivity and thermal insulation 15. The unit 14 is arranged in a region of the main body 8 that faces the container 2, while the thermal insulation 15 is arranged in a region of the main body that faces away from the container 2 and is used for insulation with respect to the environment of the coupling element or the measurement station 1.

A first possible embodiment of an integrally produced coupling element 7 is illustrated in FIG. 5. The coupling element 7 has a main body 8 with an (optional) shaft 8a and a sensor chamber 10 for receiving a sensor module 3. The contact surface 9 rests flat against the wall W of the container 2. The surface of the contact surface 9 is as large as possible, in particular maximally, while an extension of the main body 8 perpendicular to the contact surface 9 is particularly small, in particular minimally. This results in a particularly compact design. In addition, such an embodiment also ensures reduced, in particular minimized, heat loss to the environment. This effect can be further increased by suitable measures with respect to the design or the structure of the main body 8, for example with respect to internal heat conduction; in particular, the main body 8 can be designed such that increased heat conduction takes place from the contact surface 9 to the sensor chamber 10 or to the shaft 8a.

While the main body 8 is a solid body in the case of FIG. 5a, the main body 8 shown in FIG. 5b is a hollow body.A main body 8 in the form of a hollow body offers the additional advantage that a sensor element of a sensor module comes into direct contact with the wall W of the container 2. This reduces the distance between the sensor element 5, which is arranged in the measuring insert 3, and the wall W of the container 2, to which the measuring insert 3 is arranged tangentially, which in turn results in a further improvement of the heat conduction from the medium M to the sensor element 5.

Finally, FIG. 6 shows a shaft-like embodiment of the main body 8 of the coupling element 7. This embodiment constitutes a particularly compact and simple design. It is also conceivable for this embodiment to use a solid (FIG. 6a) main body 8 and a main body in the form of a hollow body (FIG. 6b). In addition to the two variants for a one-piece main body 8 from FIGS. 5 and 6, numerous further possible embodiments for a main body 8 of a coupling element 7 according to the invention which also fall within the scope of the present invention are conceivable. In particular, the embodiments shown in FIGS. 5 and 6 can also be combined with one another as desired.

In summary, it is an advantage of the present invention that a standard measuring insert 3, for example a thermometer 1, can be used to realize a non-invasive thermometer 1. For this purpose, the coupling element 7 according to the invention has a sensor chamber 10 for receiving the measuring insert 3. Adaptation to the geometry of the container 2 is effected by means of the contact surface 9 of the coupling element 7. In contrast to other solutions known from the prior art, a longitudinal axis L of the measuring insert 3 runs tangentially to the wall of the container W, whereby improved heat conduction can be achieved.

With reference to FIG. 7a tod, it will now be explained how the sensor modules 3 of the measurement sensors according to the invention are to be arranged. The sensor modules 3 each comprise a module base body 3, a sensor element 5, and a thermal bridge body 6; 60. The term of the thermal bridge body 6; 60 refers to such different functional elements as electrical connection lines 6 of the sensor element 5 or a thin-walled metal sleeve 60 in which the sensor element is arranged. From a thermal point of view, the aforementioned functional elements have the common undesirable property that they can dissipate heat when there are temperature gradients along their longitudinal extension, which is why the collective term of thermal bridge body has been selected for them. As shown in FIGS. 7a, 7c, and 7d, the sensor element 5 can be arranged without further casing in the sensor chamber 10, which is formed in the main body 8 of the coupling element. In this case, the sensor element is located in the region of minimum distance between the longitudinal axis of the sensor chamber and the contact surface, or the sensor element can be displaced beyond this region further into the sensor chamber in the direction of a closed first end portion of the sensor chamber 10.

The electrical connection lines 6, with which the sensor element 5 is contacted, run between the sensor element 5 and a rear opening in a second end portion of the sensor chamber 10. For minimizing a temperature gradient, the module base body 20, which has a metal ring body 22 and a central insulator body 24 held by it in a firmly bonded manner, is firmly bonded to the main body 8 at the rear opening of the sensor chamber 10, wherein the ring body 22 is joined to the main body 8 with a joint 26. The connection lines 6 are routed through the insulator body 24 in a firmly bonded manner. Due to the firmly bonded connection, the connection lines are thermally coupled to the main body 8 to such an extent that a temperature gradient along the connection lines is minimized. The insulator body may comprise glass, ceramic, or a polymer with sufficient thermal conductivity.

As shown in FIG. 7b, the sensor element 5 can also be arranged in an encasing sleeve 60 in the sensor chamber 10, wherein the sleeve comprises a metal or ceramic material with high thermal conductivity. The sleeve 60 has a smaller cross-sectional area than the sensor chamber 10. Connection lines 6 for contacting the sensor element 5 run in the sleeve. With regard to the longitudinal extension of the components of the sensor module 3 in the sensor chamber 10, the explanations for the previously discussed exemplary embodiments apply accordingly. In this case, the sleeve 60 is the dominant thermal bridge body. For minimizing a temperature gradient along the sleeve 60, the module base body 20, which has a metal ring body 22 and a central insulator body 24 held by it in a firmly bonded manner, is firmly bonded to the main body 8 at the rear opening of the sensor chamber 10, wherein the ring body 22 is joined to the main body 8 with a joint 26. The sleeve 60 is routed through the insulator body 24 in a firmly bonded manner. Due to the firmly bonded connection, the sleeve 60 is thermally coupled to the main body 8 to such an extent that a temperature gradient along the connection lines is minimized. The insulator body may comprise glass, ceramic, or a polymer with sufficient thermal conductivity. Insofar as the connection lines 6 are routed in the sleeve in a very small cross-section, which is considerably smaller than the cross-section of the sensor chamber, a temperature distribution along the connecting wires corresponds to the temperature distribution along the sleeve. Further measures for the firmly bonded coupling of the connection lines 6 to the module base body are therefore not necessary. If necessary, the sleeve can be filled with a ceramic powder for even temperature control of the connection line.

As shown in FIGS. 7c and 7d, the module base body may also have a connector coupling 28 with connection contacts 30 for connecting a supply and data line. If necessary, the module base body 22 may contain an on-site electronics module for preprocessing and digitizing primary signals of the sensor element 5.

1-17. (canceled)

18. A measurement sensor for determining a thermal measurement variable of a medium in a container by contacting the container, comprising a coupling element; and
a sensor module;
wherein the coupling element comprises:
a main body with a contact surface for contacting the container,
wherein the coupling element has a sensor chamber, which is cylindrical at least in sections, for receiving a sensor element for determining and/or monitoring the process variable,
wherein the sensor chamber is arranged at least in sections in the main body,
wherein a longitudinal axis of the sensor chamber is at a distance of not more than four radii of the sensor chamber from the contact surface, wherein
the contact surface has multiple normal vectors, the intersection points of which define a guide curve, wherein a minimum distance vector is given between the guide curve and the longitudinal axis of the bore, wherein the distance vector and a direction vector of the guide curve at the intersection point of the guide curve with the distance vector span a reference plane, to which the longitudinal axis of the bore has an angle of not less than 25°;
wherein the sensor module comprises:
at least one sensor element for detecting a temperature;
at least one module base body; and
at least one thermal bridge body;
wherein the sensor element is arranged in a first end portion of the sensor chamber,
wherein the module base body is arranged at a second end portion of the sensor chamber that faces away from the first end portion,
wherein the thermal bridge body extends in the sensor chamber at least over a portion that extends between the sensor element and the module base body,
wherein, along the longitudinal axis of the sensor chamber, cross-sections of the sensor chamber are larger than the respective coplanar cross-sections of the thermal bridge bodies,
wherein the thermal bridge body is firmly bonded to the module base body, and
wherein the module base body is firmly bonded to the wall of the sensor chamber in an end portion of the sensor chamber that faces away from the sensor element.

19. The measurement sensor according to claim 18,
wherein the contact surface has the shape of a portion of a lateral cylinder surface, and wherein the guide curve forms a cylinder axis to the lateral cylinder surface.

20. The measurement sensor according to claim 18,
wherein the coupling element furthermore comprises a shaft, which extends out of the main body, wherein the sensor chamber extends through the shaft, wherein the shaft is connected to the main body in particular by means of a press fit or in a firmly bonded manner.

20. The measurement sensor according to claim 18,
wherein the sensor chamber is closed at the first end portion, wherein the sensor chamber extends from a point of minimum distance of the contact surface to the longitudinal axis of the sensor chamber not more than eight, diameters of the sensor chamber at the point of minimum distance in the direction of the end region.

21. The measurement sensor according to claim 18,
wherein the contact surface has an opening to the sensor chamber, wherein the sensor element is arranged in the region of the opening with respect to the longitudinal axis of the sensor chamber.

22. The measurement sensor according to claim 21,
wherein the sensor element is fixed with a potting compound.

23. The measurement sensor according to claim 18,
wherein the at least one thermal bridge body comprises at least two electrical lines connected to the sensor element,
wherein the module base body comprises an, in particular metal, ring body and an insulator body,
wherein the ring body surrounds the insulator body in a firmly bonded manner,
wherein the at least two electrical lines are firmly bonded to the insulator body, and
wherein the ring body is firmly bonded to the wall of the sensor chamber.

24. The measurement sensor according to claim 18,
wherein the at least one thermal bridge body comprises at least one cylindrical sleeve, which is inserted into the sensor chamber, wherein the sensor element is arranged in the sleeve,
wherein the sleeve is firmly bonded to the module base body.

25. The measurement sensor according to claim 18,
wherein, in the region of the contact surface, a unit comprising at least in part a material having anisotropic thermal conductivity.

26. The measurement sensor according to claim 18,
wherein a thermal insulation made of a thermally insulating material is arranged in a region of the main body that faces away from the contact surface and the sensor chamber, which thermal insulation at least partially surrounds the main body, or wherein the main body in the region consists of the thermally insulating material, wherein the thermally lower thermally insulating material has a thermal conductivity that is at least four times lower, in particular at least eight times lower, than that of the material of the main body in the region of the contact surface.

27. The measurement sensor according to claim 18,
wherein the main body is constructed from at least two components, in particular in the form of a layered structure.

28. The measurement sensor according to claim 18,
comprising fastening means for fastening the main body to the container.

29. The measurement sensor according to claim 18,
wherein the main body of the coupling element at least partially comprises a sintered material or a composite material.

30. The measurement sensor according to claim 18,
wherein the coupling element is designed in one piece.

31. The measurement sensor according to 18, furthermore comprising:
at least one component from a list of components, which comprises: a plug connector coupling; an on-site electronics module for driving the sensor element and/or for processing primary signals of the sensor element, wherein the component is firmly connected to the module base body and in particular is arranged in the module base body.

32. A measurement station, comprising: a measurement sensor according to 18 and a container for containing a medium whose process variable is to be determined using the measurement sensor,
wherein the contact surface rests against a surface portion of the container that is complementary to it,
wherein, in particular, the guiding axis of the contact surface coincides with a guiding axis of the surface portion.

33. The measurement station according to claim 32, wherein the container comprises a pipeline section for guiding the medium, wherein the surface portion is formed in the pipeline section.
